(19) United States
(12) Patent Application Publication
(10) Pub. No.: US 2021/0180535 A1
(43) Pub. Date: Jun. 17, 2021

(54) METHOD FOR THE MODEL-BASED CONTROL AND REGULATION OF AN INTERNAL COMBUSTION ENGINE

(71) Applicant: MTU Friedrichshafen GmbH, Friedrichshafen (DE)

(72) Inventors: Knut Graichen, Ulm (DE); Michael Buchholz, Ulm (DE); Daniel Bergmann, Ulm (DE); Jens Niemeyer, Friedrichshafen (DE); Jörg Remele, Hagnau (DE)

(73) Assignee: MTU Friedrichshafen GmbH, Friedrichshafen (DE)

(21) Appl. No.: 17/164,915

(22) Filed: Feb. 2, 2021

Related U.S. Application Data
(63) Continuation of application No. PCT/EP2019/070558, filed on Jul. 30, 2019.

(30) Foreign Application Priority Data
Aug. 10, 2018 (DE) 10 2018 006 312.8

(51) Int. Cl. F02D 41/26; F02D 41/30; F02D 41/24

(52) U.S. Cl. CPC F02D 41/26; F02D 2041/286; F02D 41/2429; F02D 41/30

(57) ABSTRACT

A method for the model-based control and regulation of an internal combustion engine. The method includes calculating, as a function of a set torque, injection system set values for controlling the injection system actuators via a combustion model and calculating gas path set values for controlling the gas path actuators via a gas path model. The combustion model is adapted during operation of the internal combustion engine into the form of a complete data-based model. A measure of quality is minimized by an optimizer by changing the injection system set values and gas path set values within a prediction horizon, and the injection system set values and gas path set values are set by the optimizer, which is critical for adjusting the operating point of the internal combustion engine by using the minimized measure of quality.

### CROSS REFERENCE TO RELATED APPLICATIONS

This is a continuation of PCT application No. PCT/EP2019/070558, entitled “METHOD FOR THE MODEL-BASED CONTROL AND REGULATION OF AN INTERNAL COMBUSTION ENGINE”, filed Jul. 30, 2019, which is incorporated herein by reference.

### BACKGROUND OF THE INVENTION

### 1. Field of the Invention

The invention relates to a method for model-based control and regulation of an internal combustion engine wherein, as a function of a set torque, injection system set values for controlling the injection system actuators are calculated via a combustion model, and gas path set values for controlling the gas path actuators are calculated via a gas path model.

### 2. Description of the Related Art

The behavior of an internal combustion engine is significantly determined via an engine controller as a function of a desired performance. In the software of the engine controller, relevant characteristic curves and performance graphs are applied for this purpose. Via these, the manipulated variables of the internal combustion engine, for example the start of injection and a necessary rail pressure are calculated from the desired performance, for example from a set torque. During a test bench run these characteristic curves/performance graphs are populated with data by the producer of the internal combustion engine. The plurality of these characteristic curves/performance graphs and the interaction of the characteristic curves/performance graphs among each other, however, cause a high alignment effort.

In practice therefore, attempts are made to reduce the alignment effort by applying mathematical models. From the not prepublished German patent application DE 10 2017 005 783.4 a model based control and regulating method for an internal combustion engine is known, wherein injection system set values for controlling the injection system actuators are calculated via a combustion model, and gas path set values for controlling the gas path actuators are calculated via a gas path model. These set values are then changed by an optimizer with the objective to minimize a measure of quality within a prediction horizon. The minimized measure of quality in turn defines the best possible operating point of the internal combustion engine.

From the not prepublished German patent application DE 10 2018 001 727.4 a method is known for adaptation of the combustion model in addition to the previously described control and regulation method. The combustion model is adapted via a first Gaussian process model to represent a base grid and via a second Gaussian process model to represent adaptation data points. The data for the first Gaussian process model is determined from the measured values which were obtained from a single cylinder test bench. All input values are cross-varied through a subsequent physical modelling, in order to cover the entire operating range of the internal combustion engine. The data for the second Gaussian process model is determined from measured values of a full engine which were determined during a DoE test bench run (DoE: Design of experiments) of the internal combustion engine in the stationary drivable range. The physical modelling from the single cylinder data is very time consuming and cost intensive because relevant software development tools and extensive expert knowledge are required.

What is needed in the art is a system and method to optimize the previously described adaptation method in regard to the time requirement.

### SUMMARY OF THE INVENTION

The invention provides a method for model-based control and regulation of an internal combustion engine. As a function of a set torque (M(SOLL), injection system set values for controlling the injection system actuators are calculated via a combustion model, and gas path set values for controlling the gas path actuators are calculated via a gas path model. The combustion model in the embodiment of a completely data-based model is adapted during ongoing operation of internal combustion engine. A measure of quality is minimized by an optimizer by changing the injection system set values and gas path set values within a prediction horizon and wherein the injection system set values and the gas path set values are set by the optimizer as being critical for adjusting the operating set point of the internal combustion engine by using the minimized measure of quality.

In the inventive method, the combustion model in the embodiment of a completely data-based model is adapted during ongoing operation of the internal combustion engine. The data-based model is created in that in a first step the set values of the internal combustion engine are varied on a single cylinder test bench, in that in a second step trend information is produced from the measured values of the single cylinder test bench and in that in a third step a deviation of the measured values of the singe cylinder test bench is minimized to a first Gaussian process model by adhering to the trend information. The data-based model makes it possible through means of extrapolation to generate load tolerant data values. Said data values then apply in the non-measured operating ranges of the internal combustion engine. The physical modeling known from the current state of the art is replaced by the data-based model. The clearly reduced development effort is advantageous, since the trend information gained from the single cylinder measured data and the adaptation to the DoE data can be automated via mathematical algorithms. This also results in a high degree of reliability of the data-based model—thus it is robust. Due to the extrapolation of new data values for the non-measured operating ranges of the internal combustion engine the model reacts good naturedly—in other words, no extreme or sporadic reactions occur in the non-measured operating ranges of the internal combustion engine.

Generally speaking, by way of the inventive method the behavior of technical processes can be described in which measured values are available for defined operating ranges, and wherein in non-measured operating ranges a system behavior of the device is mapped on the basis of the trend information. A device is understood for example to be an exhaust treatment system or a battery management system.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic view of an electronically controlled internal combustion engine with a common rail system;

FIG. 2 is a schematic view of a model-based system;

FIG. 3 is a flow chart illustrating the program steps of an implementable program;

FIG. 4A is a graph illustrating the NOx actual value in relation to the accumulator pressure;

FIG. 4B is a graph illustrating the NOx actual value in relation to the injection start;

FIG. 5 is a graph illustrating a first Gaussian process model; and

FIG. 6 is a table illustrating various measured values.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

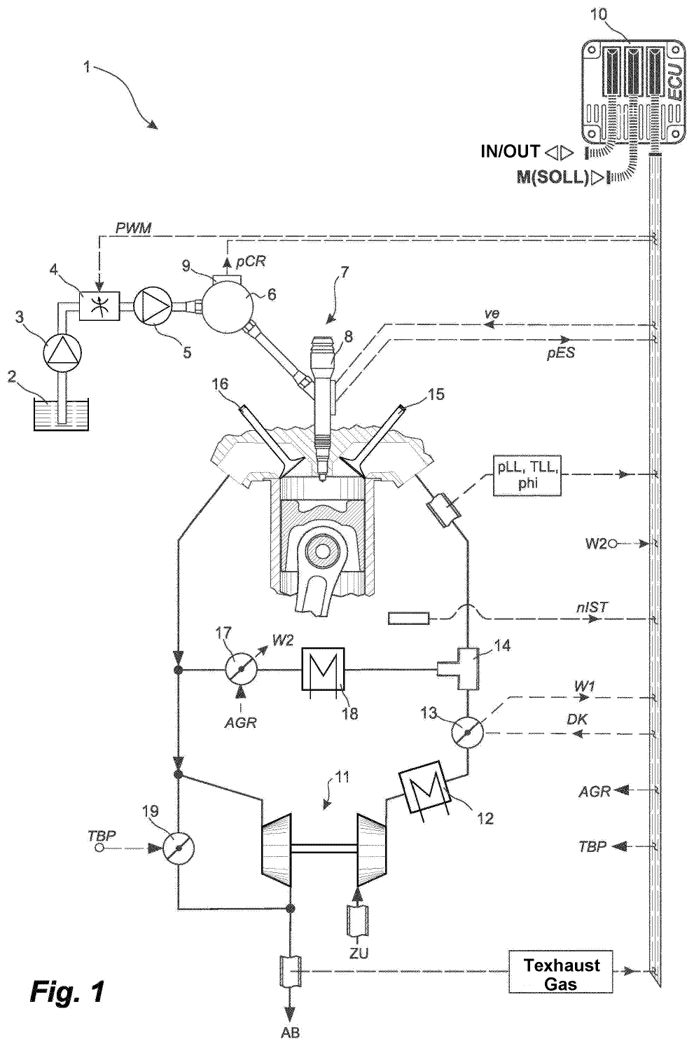

FIG. 1 shows a system diagram of an electronically controlled internal combustion engine 1 with a common rail system. The common rail system comprises the following mechanical components: a low pressure pump 3 to move fuel out of a fuel tank 2, a modifiable suction throttle 4 to influence the flow of the volumetric flow, a high pressure pump 5 for moving of fuel under pressure increase, a rail 6 for storing of fuel and injectors 7 for injecting fuel into the combustion chambers of internal combustion engine 1. As an option, the common rail system can also be equipped with individual accumulators, wherein then, for example an individual accumulator 8 is integrated into injector 7 as an additional buffer volume. The additional functionality of the common rail system is assumed to be known.

The illustrated gas path comprises the air supply and also the exhaust gas discharge. Arranged in the air supply are: the compressor of an exhaust gas turbo charger 11, an intercooler 12, a throttle valve 13, a junction 14 for merger of the charge air with the returned exhaust gas and inlet valve 15. Arranged in the exhaust gas discharge are: an outlet valve 16, the turbine of exhaust gas turbo charger 11 and a turbine bypass valve 19. An exhaust gas return path branches off from the exhaust gas discharge in which an AGR actuator 17 is arranged for the adjustment of the AGR-rate, and AGR cooler 18.

The operating mode of internal combustion engine 1 is determined by an electronic control unit 10 (ECU). Electronic control unit 10 includes the usual components of a microcomputer system, for example a microprocessor, I/O components, buffers, and memory chips (EEPROM, RAM). Operating data that is relevant for the operation of internal combustion engine 1 are applied as models in the memory chips. Via these, the output values are calculated from the input values by electronic control unit 10. The decisive input value is a set torque M (SOLL), which is specified by an operator as a desired performance. The input values of control unit 10 related to the common rail system are the rail pressure pCR which is measured by way of a rail pressure sensor 9, and optionally the individual accumulator pressure pES. The input values of electronic control unit 10 relating to the air path are an opening angle W1 of throttle valve 13, engine speed nIST, charge air pressure pLL, charge air temperature TLL and the moisture phi of the charge air. The input values of electronic control unit 10 relating to the exhaust gas path are an opening angle W2 of AGR actuator 17, exhaust gas temperature TAbgas (exhaust gas), the air-fuel ratio lambda and the NOx-actual value (IST) downstream from the turbine of exhaust gas turbo charger 11. The additional non-illustrated input values of electronic control unit 10 are cumulated under reference IN, for example the coolant temperatures.

In FIG. 1 the following are illustrated as output values of electronic control unit 10: a signal PWM for control of suction throttle 4, a signal ye for control of injector 7 (injection start/injection end), a control signal DK for control of throttle valve TBP for control of turbine bypass valve 19 and an output value AUS. Output value AUS is representative for the other control signals for control and adjustment of internal combustion engine 1, for example for a control signal for activation of a second exhaust gas turbo charger during turbo charging or for a variable valve train.

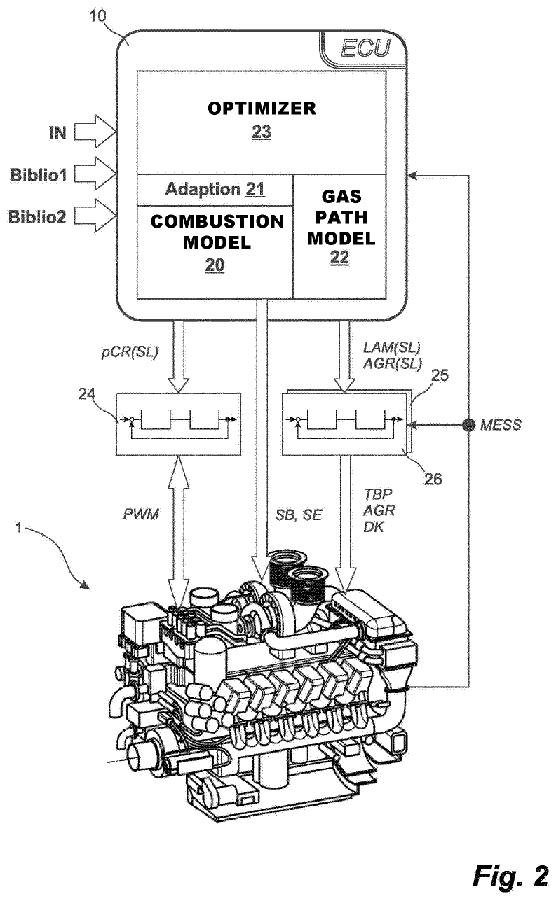

FIG. 2 shows a model-based system diagram. In this illustration the input values of electronic control unit 10 are a first library Biblio 1, a second library Biblio 2, measured values MESS and the collective reference EIN which is representative for the input values shown in FIG. 1. First library Biblio 1 identifies the operation of the internal combustion engine according to emission category MARPOL (Marine Pollution) of IMO or according to emission category EU IV/tier 4 final. Second library Biblio 2 identifies the type of internal combustion engine and a maximum mechanical component load, for example the peak combustion pressure or the maximum speed of the exhaust gas turbo charger. Input value MESS identifies the directly measured physical quantities as well as auxiliary values measured therefrom. The output values of the electronic control unit are the set values for the subordinate control loops, injection start SB and injection end SE. The subordinate control loops are a rail pressure control loop 24, a lambda control loop 25 and an AGR control loop 26. Arranged inside the electronic control unit are a combustion model 20, an adaptation 21, a gas path model 22 and an optimizer 23.

Combustion model 20 and gas path model 22 display the system behavior of the internal combustion engine as a mathematical equation. Combustion model 20 displays statically the processes during combustion. In contrast, gas path model 22 displays the dynamic behavior of the air flow and exhaust gas flow. Combustion model 20 includes individual models, for example for NOx- and soot development, for the exhaust gas temperature, for the exhaust gas mass flow and for the peak pressure. These individual models in turn are subject to the constraints in the cylinder and the parameters of the injection. Combustion model 20 is determined on a reference internal combustion engine in a test bench run, the so-called DoE-test bench run (DoE: Design of experiments) for the drivable range. During the DoE test bench run operating parameters and control value are systematically varied with the objective to map the overall behavior of the internal combustion engine as a function of engine sizes and environmental limits. The measured values determined on a single cylinder test bench are also processed in combustion model 20. Combustion model 20 is supplemented with adaption 21. The objective of the adaption is to reduce the series spread in an internal combustion engine.

After activation of internal combustion engine 1, optimizer 23 first imports the emission category from first library Biblio 1, and the maximum mechanical component loads from second library Biblio 2. Optimizer 23 subsequently evaluates combustion model 20 in regard to set torque M(SOLL), the emission limits, environmental limits, for example the moisture phi of the charge air, the operating situation of the internal combustion engine and the adaption data points. The operating situation is defined in particular by engine speed nIST, charge air temperature TLL and charge air pressure pLL. The function of optimizer 23 consists in evaluating the injection system set values for control of the injection system actuators and the gas path set values for control of the gas path actuators. Optimizer 23 herein selects the solution in which a measure of quality is minimized. The measure of quality is calculated as being integral to the square target-actual (SOLL-IST) deviations within the prediction horizon. For example:

J=∫[w1(NOx(SOLL)−NOx(IST)]²+[w2(M(SOLL)−M(IST)]²+[w3( . . . )]+ . . . (1)

The weighting factors are described with w1, w2 and w3. As is known, the nitrogen oxide emissions result from moisture phi of the charge air, the charge air temperature, injection start SB and rail pressure pCR. Adaption 21 intervenes in the actual (IST) values, for example the NOx IST (actual) value or the exhaust gas temperature IST (actual) value.

The measure of quality is minimized in that at a first point of time a first measure of quality is calculated by optimizer 23, and in that the injection system set values as well as the gas path set values are varied and by way thereof a second measure of quality is predicted within the prediction horizon. By way of the deviation of the two measures of quality between each other, optimizer 23 then establishes a minimum measure of quality and defines same as definitive for the internal combustion engine. For additional procedures in regard to the prediction we refer to the non-prepublished German patent application DE 10 2017 005 783.4.

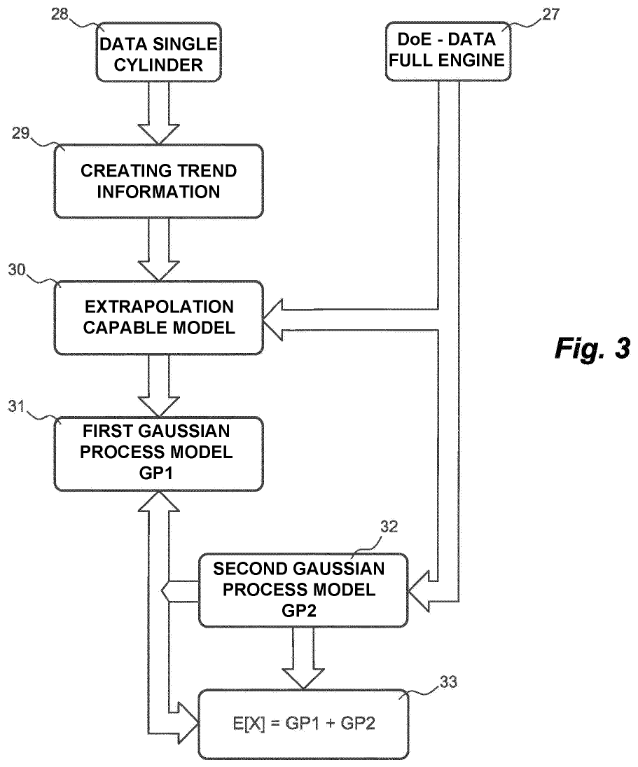

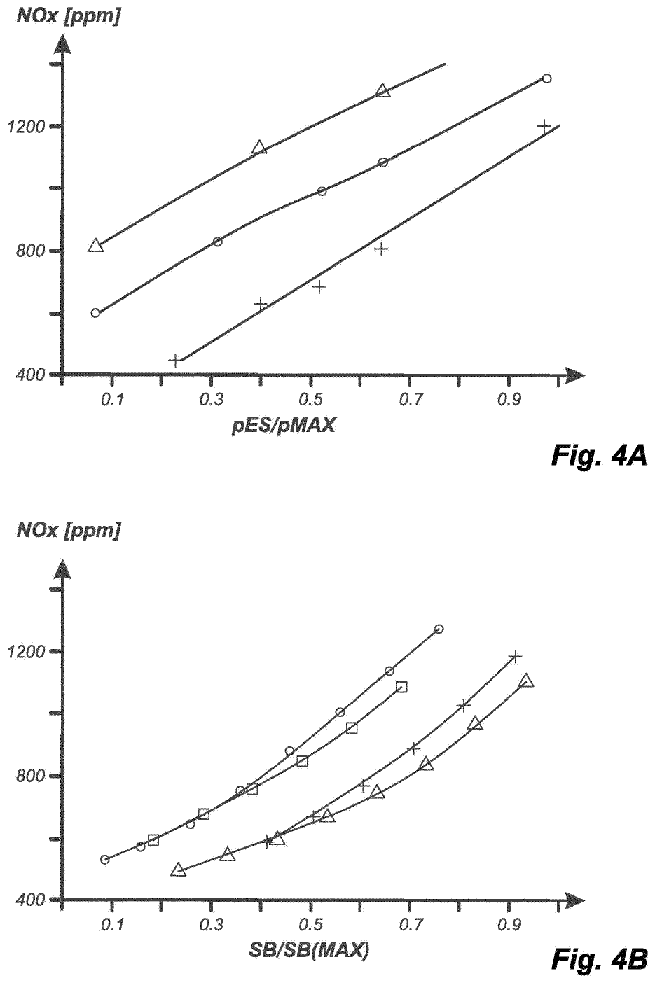

FIG. 3 is a flow chart illustrating the program steps of an implementable program. It shows the interaction of the two Gaussian process models for the creation of the combustion model (FIG. 2:20). Gaussian process models are known to the expert, for example from DE 10 2014 225 039 A1 or DE 10 2013 220 432 A1. Broadly speaking, a Gaussian process is defined by an averaging function and a covariance function. The averaging function is often assumed to be zero or a linear/poly nominal progression is introduced. The covariance function provides the connection of optional points and describes the statistic reliability of the models at one observed operating point of the internal combustion engine. The covariance defines a confidence range in which the value of the real system is within a probability range of 95%. Function block 27 includes the DoE data of the full engine. For a reference internal combustion engine this data is determined on a test bench in that all variations of the input values are determined over their entire adjustment range in the stationary drivable range of the internal combustion engine. These measurements indicate with high precision the behavior of the internal combustion engine in the stationary drivable range. A function block 28 includes data which was obtained on a single cylinder test bench. On a single cylinder test bench operating ranges can be set which cannot be verified on a DoE bench test run, for example large geodetic altitude or extreme temperatures. In function block 29 the system characteristics are automatically calculated subject to individual set values, in the form of trend information. The trend information, at block 29, can be stored in terms of a linear, monotonic, or unrestricted function. Additional explanation is made in conjunction with FIGS. 4A and 4B.

In FIG. 4A the individual accumulator pressure pES is illustrated on the abscissa, nominated on maximum pressure pMax of the individual accumulator pressure. The measurements entered as a cross were determined in that a VVT actuator (VVT: variable valve control), injection start SB, engine speed nIST, charge air temperature TLL and moisture phi of the charging air were kept constant. The injected fuel volume was herein set to a first value. Then, the single accumulator pressure pES was varied in that the delivered fuel volume was changed.

The measured values indicated by a circle were determined in that the fuel volume was set to a second value, individual accumulator pressure pES was varied and the previously constant parameters, that is to say, the VVT actuator, the injection start SB, the engine speed nIST, the charge air temperature TLL and the moisture phi of the charging air were kept unchanged. The measured values entered with a triangle were determined in that speed nIST was set to a new value, individual accumulator pressure pES was changed, and the other parameters were accepted unchanged. From FIG. 4A a first statement can be derived that the NOx actual value increases with increased individual accumulator pressure pES, and a second statement can be derived that the increase is constantly increasing. Therefore, the trend information for the illustrated example is: monotonic (increasing) as well as linear. In FIG. 4B injection start SB, nominated to a maximum value SB(MAX) of the injection start is plotted on the abscissa. The NOx-actual value is illustrated as a measured value on the ordinate. The data values illustrated in FIG. 4B result in an analogous approach to FIG. 4A, wherein here the individual accumulator pressure pES was kept constant and instead the injection start SB was changed. The trend information for the examples illustrated in FIG. 4B is: only monotonic (increasing).

In FIG. 3 the extrapolation capable model is identified with reference 30. The deviation of data of the single cylinder test bench from DoE data 27 is minimized herein by adhering to the trend information. Reference 31 identifies a first Gaussian process model 31 (GP1) for the representation of a base grid. The merger of both sets of data points forms the second Gaussian process model 32. Thereby the operating ranges for the internal combustion engine which are described by the DoE data are also established by these values and operating ranges for which no DoE data is available are reproduced by data of model 30. Since the second Gaussian process model is adapted in running operation, it serves to represent the adaptation points. Therefore, generally speaking, the following applies for model 33:

E[x]=GP1+GP2 (2)

GP1 hereby corresponds with the first Gaussian process model for representation of base grid, GP2 corresponds with the second Gaussian process model for representation of the adaptation data points. Data-based model E[x] in turn is the input value for the optimizer, for example an NOx actual value or an exhaust temperature actual value. Two informational paths are indicated by the double arrow in the drawing. The first informational path identifies the data provision of the base grid from first Gaussian process model 31 to data-based model 33. The second informational path identifies the re-adjustment of first Gaussian process model 31 via second Gaussian process model 32. For an additional approach regarding the adaption we refer to the non-prepublished German patent application DE 10 2018 001 727.4.

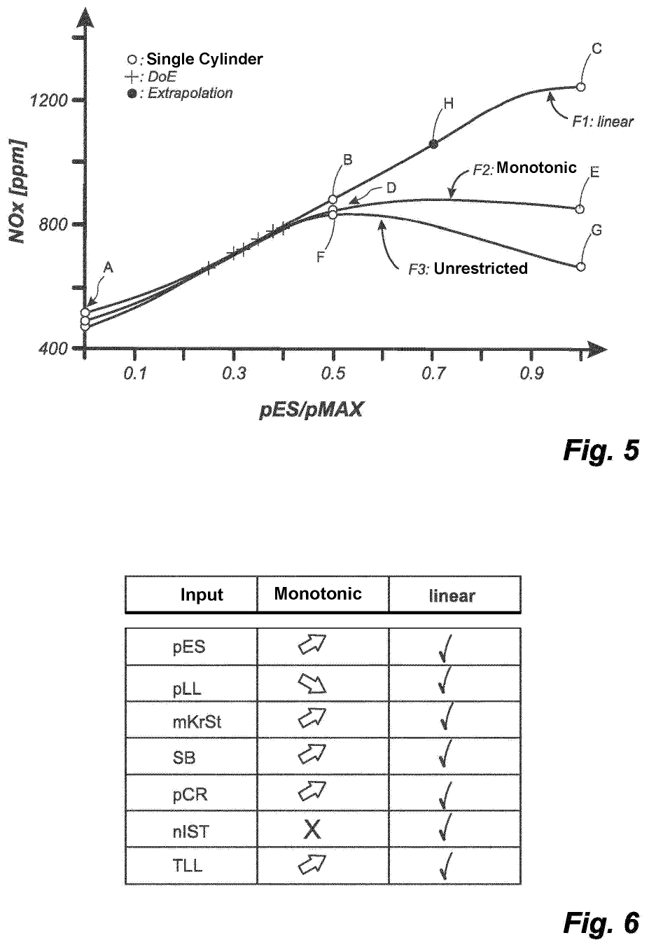

FIG. 5 shows a diagram of a first Gaussian process model for individual accumulator pressure pES that is nominated to maximum pressure pMax. The measured NOx value is plotted on the ordinate. Inside the diagram the DoE data values determined at the full engine are identified with a cross and the progression of the first Gaussian process model from the data values captured at the single cylinder are identified with a circle. These are for example the three data values of points A, B and C. In a first step the position of the data values, in other words the trend information (FIG. 3:29) relative to each other is determined. Since a higher NOx actual value results from the data value of point B than point A, the function in this range is monotonic. In an analog approach this also applies at point C, in other words the NOx actual value is higher at point C than at point B. Therefore, “monotonic” results as the trend information for data values A to C. In a second step the deviation (model error) of these data values from the DoE data is minimized. In other words: a mathematical function is established which displays the best possible DoE data values under consideration of the trend information. For data values A, B and C this is the monotonic, linear and rising function F1. A function F2 is identified by data values A, D and E as only being monotonic. A function F3 is mapped by data values A, F and G. Looking at FIG. 6, the illustrated examples of measured values—individual accumulator pressure pES, amount of fuel mKrSt, injection start SB, rail pressure pCR and charge air temperature TLL are consistent with function F1, that is monotonic and increasing linearly. Measured value “engine speed nIST” behaves according to function F3, in other words unrestrictedly. Unrestricted means that no trend information is available for this measured value. As can also be deduced from FIG. 5, intermediate value, for example data value H can be extrapolated. Thus, the model is capable of being extrapolated (FIG. 3:30). Determination of the first Gaussian process model occurs in an automated manner. In other words, no expert knowledge is required. The automated extrapolation capability of the model in turn ensures a high degree of sturdiness and good will, because on the basis of the trend information, the model will not permit extremes or erratic reactions in unknown ranges.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCE NUMBERS

1 Internal combustion engine
2 Fuel tank
3 Low pressure pump
4 Suction throttle
5 High pressure pump
6 Rail
7 Injector
8 Individual accumulator
9 Rail pressure sensor
10 Electronic control unit
11 Exhaust gas turbo charger
12 Charge air cooler
13 Throttle valve
14 Merger junction
15 Inlet valve
16 Outlet valve
17 AGR actuator (AGR: exhaust gas return)
18 AGR cooler
19 Turbine bypass valve
20 Combustion model
21 Adaption
22 Gas path model
23 Optimizer
24 Rail pressure control loop
25 Lambda control loop
26 AGR control loop
27 Function block, DoE data
28 Function block, data single cylinder
29 Function block, determination of trend information
30 Model
31 First Gaussian process model (GP1)
32 Second Gaussian process model (GP2)
33 Data-based model

What is claimed is:

1. A method for model-based control and regulation of an internal combustion engine, comprising:
calculating, via a combustion model, as a function of a set torque (M(SOLL), injection system set values for controlling the injection system actuators;
calculating, via a gas path model, gas path set values for controlling the gas path;
adapting the combustion model data-based during ongoing operation of the internal combustion engine;
minimizing a measure of quality (J), by an optimizer, by changing the injection system set values and gas path set values within a prediction horizon; and
setting, by the optimizer, the injection system set values and the gas path set values as being critical for adjusting the operating set point of the internal combustion engine by using the minimized measure of quality (J).

2. The method according to claim 1, wherein the combustion model is in the form of a completely data-based model.

3. The method according to claim 2, wherein the data-based model is created in a first step and the set values of the internal combustion engine are varied on a single cylinder test bench, wherein in a second step trend information is produced from the values of the single cylinder test bench, and wherein in a third step a deviation of the measured values of the single cylinder test bench is minimized to a first Gaussian process model by adhering to the trend information.

4. The method according to claim 3, wherein via the data-based model, through extrapolation, new data values are generated for non-measured operating ranges of the internal combustion engine.

5. The method according to claim 3, wherein the trend information is stored in terms of a linear, monotonic, or unrestricted function.
